(19) United States
(12) Patent Application Publication
(10) Pub. No.: US 2005/0122210 A1
(43) Pub. Date: Jun. 9, 2005

(54) Dual technology door entry person authentication

(75) Inventors: Steve D. Huseth, Plymouth, MN (US); Bruce W. Anderson, Andover, MN (US)

Correspondence Address: HONEYWELL INTERNATIONAL INC., Law Dept. AB2, P.O. Box 2245, Morristown, NJ, 07962-9806, US

(73) Assignee: Honeywell International Inc.

(21) Appl. No.: 10/728,564

(22) Filed: Dec. 5, 2003

(51) Int. Cl. G05B 19/00

(52) U.S. Cl. 340/5.53; 340/5.26

(57) ABSTRACT

A security system reader receives a signal containing an authentication code, determines whether the authentication code is from a badge or a keyfob, determines whether the authentication code is authentic, and, if the authentication code is authentic, permits access.

### TECHNICAL FIELD OF THE INVENTION

The present invention relates to the authentication of the identities of persons seeking access to a controlled area or to a controlled apparatus or process.

### BACKGROUND OF THE INVENTION

Access control systems typically authenticate persons entering a building using relatively simple badges. One such badge includes an RF transceiver and a memory that stores a unique identification code for a person to whom the badge is issued. A badge reader transmits an RF stimulus signal to the badge. The badge includes a power supply that converts the RF stimulus signal to electrical power that powers the transceiver to transmit the stored identification code in an RF signal to the badge reader. The badge reader receives the RF signal and compares the identification code in the received RF signal to a list of authorized identification codes. The person carrying the badge in the vicinity of the badge reader is authenticated and/or permitted access if the badge reader finds a match between the identification code in the received RF signal and one of the authorized identification codes in the list.

Unfortunately, the card reader cannot determine if the person in possession of the badge is authorized to have the badge. Thus, if the badge is lost, it can be illicitly used by an unauthorized person to gain access to a secured area or to a controlled apparatus or process.

For higher security installations, keyfobs are entering the market as an alternative to badges. One such keyfob is provided with an embedded fingerprint reader. When the thumb or other finger of the person possessing the keyfob is placed over the fingerprint reader, the fingerprint reader produces a digital signature from the fingerprint and merges the digital signature with a unique identifier built into the keyfob. The keyfob then transmits the merged digital signature and unique identifier to a receiver. The receiver authenticates the person possessing the keyfob on the basis of the merged digital signature and unique identifier. Thus, authentication is now the combination of possessing the keyfob together with the correct match of the fingerprint. Such a keyfob provides an enhanced level of authentication.

Different users require different levels of security. Thus, the security requirements of some users may be satisfied with badges and a badge reader as described above, while other users may require the higher level of security provided by the keyfob described above. In order to fill both requirements, a supplier of access security systems is obliged to maintain an inventory that includes badges, badge receivers, keyfobs, and keyfob receivers.

Moreover, a user who has found the badge and badge reader level of security sufficient in the past may decide at a subsequent time that a higher level of security is required. Such a user is required to completely change out the security system when changing from a badge and badge reader system to a keyfob and keyfob receiver system.

The present invention solves one or more of these or other problems.

### SUMMARY OF THE INVENTION

According to one aspect of the present invention, a security system reader comprises a transceiver and a processor. The transceiver transmits a stimulus signal and receives a signal containing an authentication code. The processor determines whether the received authentication code is from a badge or a fingerprint keyfob, and the processor performs an authentication of the authentication code dependent upon whether the authentication code is from the badge or from the fingerprint keyfob.

According to another aspect of the present invention, a method of providing access comprises the following: receiving a signal containing an authentication code; determining whether the authentication code is from a badge or a fingerprint keyfob; determining whether the authentication code is authentic dependent upon whether the authentication code is from the badge or from the fingerprint keyfob; and, if the authentication code is authentic, permitting access.

According to still another aspect of the present invention, a method of providing access comprises the following: receiving a signal containing an authentication code; determining whether the authentication code is from a badge or a keyfob; determining whether the authentication code is authentic; and, if the authentication code is authentic, permitting access.

### BRIEF DESCRIPTION OF THE DRAWINGS

These and other features and advantages of the present invention will become more apparent from a detailed consideration of the invention when taken in conjunction with the drawings in which:

FIG. 1 illustrates a security system that includes a reader capable of reading both badges and keyfobs;

FIG. 2 illustrates an exemplary badge that can be used with the security system of FIG. 1;

FIG. 3 illustrates an exemplary keyfob that can be used with the security system of FIG. 1; and,

FIG. 4 is a flow chart illustrating exemplary software that can be executed by the reader of FIG. 1.

### DETAILED DESCRIPTION

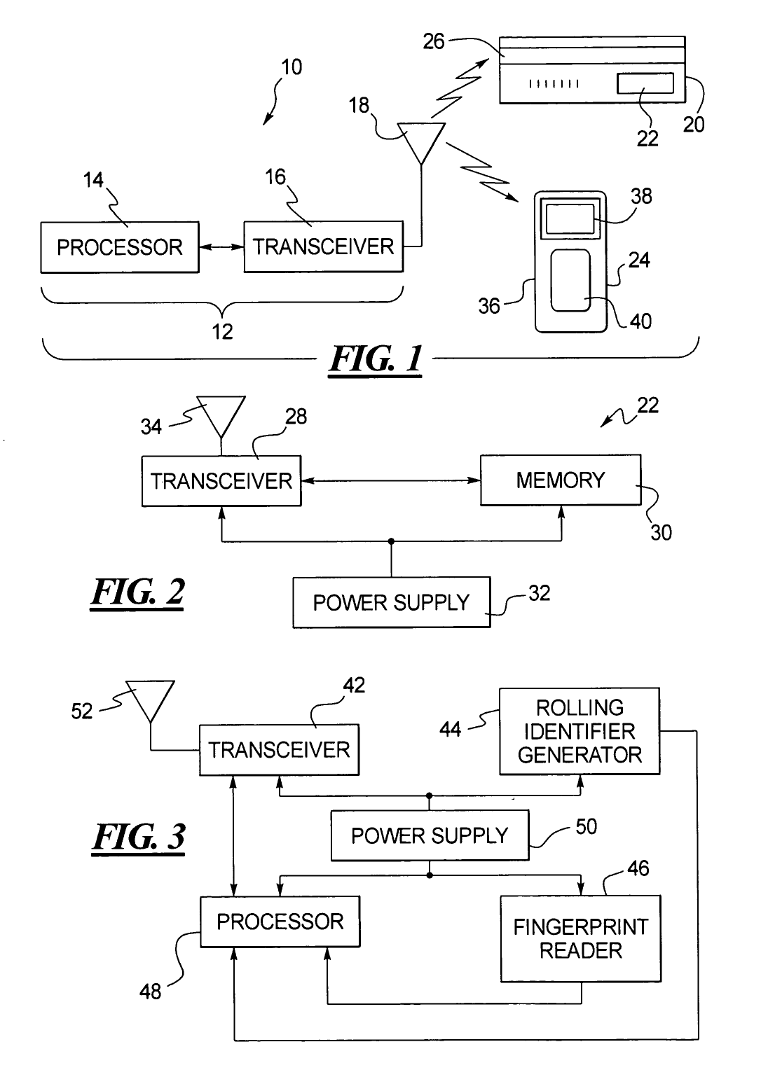

As shown in FIG. 1, a security system 10 includes a reader 12 having a processor 14 and a transceiver 16 that receives signals over an antenna 18 from a badge 20 and/or a keyfob 24. If desired, the transceiver 16 may also be arranged to transmit RF stimulus signals over an antenna 18 to the badge 20 and/or to the keyfob 24.

An exemplary badge is shown in FIGS. 1 and 2 and can be used as the badge 20. Thus, the badge 20 according to this example includes a chip 22 that can transmit an authentication code to the transceiver 16 in response to an RF stimulus signal transmitted by the transceiver 16. Additionally, the badge 20 may include a magnetic stripe 26 that can be read by a magnetic stripe reader. Accordingly, if the magnetic stripe 26 is included on the badge 20, the magnetic stripe reader can read the magnetic stripe 26 in the event of an interruption in the RF transmissions between the transceiver 16 and the badge 20.

As shown in FIG. 2, the chip 22 includes a transceiver 28, a memory 30, and a power supply 32, and is coupled to an antenna 34 of the badge 20. Specifically, the transceiver 28 is coupled to the antenna 34 and the memory 30. The memory 30 stores an identifier that uniquely identifies a person to whom the badge 20 is issued. This identifier may comprise one or more symbols such as, for example, numbers and/or letters. The power supply 32 powers the transceiver 28 and the memory 30.

The transceiver 16 of the reader 12 transmits the RF stimulus signal to the badge 20. In response to the RF stimulus signal, the transceiver 28 reads the identifier from the memory 30, and transmits the stored identifier as an authentication code in an RF signal through the antennas 34 and 18 to the transceiver 16.

The transceiver 16 receives the RF signal from the badge 20 and supplies the identifier of the authentication code in the received RF signal to the processor 14 which compares the identifier to a list of authorized badge identifiers. The person carrying the badge 20 in the vicinity of the transceiver 16 is permitted access to a restricted area, apparatus, or process if the processor 14 finds a match between the identifier received by the transceiver 16 and one of the authorized badge identifiers in the list. The badge 20 is commercially available.

As shown in FIGS. 1 and 3, the keyfob 24 includes a housing 36 that supports a display 38 and a finger pad 40. The housing 36 houses a transceiver 42, a rolling identifier generator 44, a fingerprint reader 46, a processor 48, a power supply 50, and an antenna 52. The transceiver 42 is coupled to the antenna 52 and to the processor 48. The processor 48, in addition to being coupled to the transceiver 42, is coupled to the rolling identifier generator 44 and to the fingerprint reader 46. The power supply 50 supplies power to the transceiver 42, the rolling identifier generator 44, the fingerprint reader 46, and the processor 48.

In one embodiment of the keyfob 24, the user presses a button (not shown) on the keyfob 24 and places a finger on the finger pad 40. The pressing of the button activates the power supply 50 to generate power in a sufficient amount and for a sufficient duration to power the fingerprint reader 46, the processor 48, and the transmitter 42. Accordingly, the fingerprint reader 46 reads and digitizes the fingerprint, and the processor 48 merges the digitized fingerprint with a rolling identifier from the rolling identifier generator 44 to form an authentication code. For example, the processor 48 may be arranged to concatenate the digitized fingerprint from the fingerprint reader 46 and the rolling identifier from the rolling identifier generator 44 to form the keyfob authentication code. The processor 48 supplies the keyfob authentication code to the transceiver 42 which causes the keyfob authentication code to be transmitted in an RF signal from the antenna 52 to the antenna 18. The keyfob 24 as described above is commercially available.

The code generated by the rolling identifier generator 44 may simply be a code selected from a list of valid codes stored in a memory. Thus, the codes are generated by the keyfob 24 and by the reader 12 which store a common list of valid codes often computed using some common or shared mathematical function. Thus, each time the keyfob 24 transmits a code, the keyfob indexes to the next code for the next transmission. Similarly, when the reader 12 successfully receives a code, it indexes to the next code. In this way, the keyfob 24 and the reader 12 stay in synchronization. Accordingly, the reader 12 does not accept a code that has previously been transmitted by the keyfob 24 but always receives a code that is later in the sequence.

Alternatively, a rolling identifier can be a code randomly or pseudorandomly generated periodically by the rolling identifier generator 44. For example, a different rolling identifier may be generated every n minutes where n≧1. The rolling identifier may comprise one or more symbols such as numbers and/or letters, and may be displayed by the display 38.

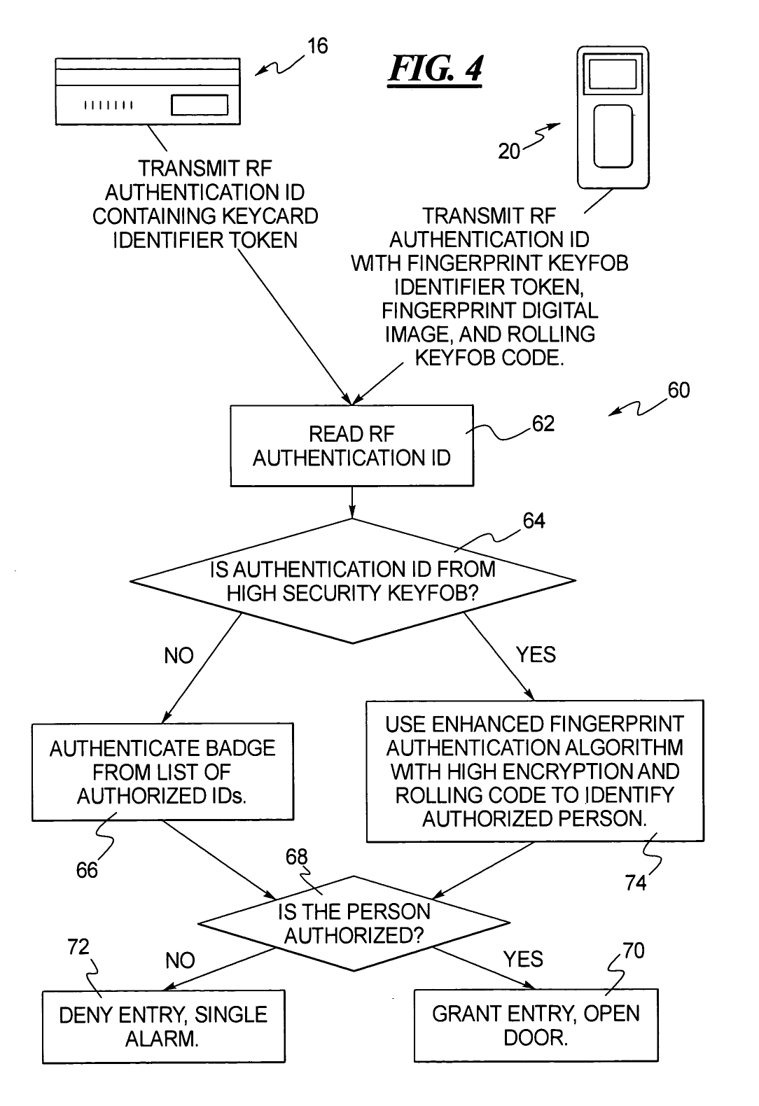

The processor 14 of the reader 12 executes a program 60 which is shown by way of a flow chart in FIG. 4. As shown in FIG. 4, the badge 20 transmits a badge authentication code in an RF signal. The processor 14 at a block 62 reads the badge authentication code and determines at a block 64 whether the badge authentication code has been received from the badge 20. Assuming that the badge authentication code has been received from the badge 20, the processor 14 at a block 66 authenticates the badge authentication code by comparing the identifier of the badge authentication code to a list of authentic identifiers, and determines at a block 68 if the identifier of the badge authentication code received from the badge 20 matches one of the authentic identifiers in the list of authentic identifiers. If the processor 14 determines at the block 68 that the identifier of the badge authentication code received from the badge 20 matches one of the authentic identifiers in the list of authentic identifiers, the processor 14 at a block 70 grants access to a restricted area or apparatus or otherwise permits a person to perform a function or process such as operate a computer. On the other hand, if the processor 14 determines at the block 68 that the identifier of the badge authentication code received from the badge 20 does not match one of the authentic identifiers in the list of authentic identifiers, the processor 14 at a block 72 denies access to a restricted area or apparatus or otherwise prevents a person from performing a function or process.

Additionally or alternatively, the keyfob 24 may transmit a keyfob authentication code in an RF signal. The processor 14 at the block 62 reads the keyfob authentication code and determines at the block 64 whether the keyfob authentication code has been received from the keyfob 24. If the keyfob authentication code has been received from the keyfob 24, the processor 14 at a block 74 authenticates the keyfob authentication code by comparing the digitized fingerprint signature of the keyfob authentication code to a list of authentic digitized fingerprint signatures, and by comparing the rolling identifier of the keyfob authentication code to a rolling identifier synchronously maintained by the processor 14. The processor 14 determines at the block 68 if the digitized fingerprint signature of the keyfob authentication code matches one of the digitized fingerprint signatures from the list of authentic digitized fingerprint signatures and if the rolling identifier of the keyfob authentication code matches the rolling identifier that is maintained by the processor 14. If the processor 14 determines at the block 68 that the digitized fingerprint signature of the keyfob authentication code matches one of the digitized fingerprint signatures from the list of authentic digitized fingerprint signatures and also determines that the rolling identifier of the keyfob authentication code matches the rolling identifier that it maintains, the processor 14 at the block 70 grants access to a restricted area or apparatus or otherwise permits a person to perform a function or process. On the other hand, if the processor 14 determines at the block 68 that the digitized fingerprint signature of the keyfob authentication code does not match one of the digitized fingerprint signatures from the list of authentic digitized fingerprint signatures and/or that the rolling identifier of the keyfob authentication code does not match the rolling identifier that is maintained by the processor 14, the processor 14 at the block 72 denies access to a restricted area or apparatus or otherwise prevents a person performing a function or process.

As can be seen, the reader 12 of the security system 10 as described above is capable of performing the functions of both a badge reader and a keyfob receiver such that the reader 12 uses the same RF protocol in interacting with the badge 20 and the keyfob 24. Accordingly, the reader 12 is a dual-technology reader that is able to provide a simple low-cost badging technology and a higher security level solution that provides significantly higher authentication reliability using the same door reader hardware. Consequently, a supplier of access security systems can maintain a smaller inventory that includes badges, keyfobs, and only one type of reader. Moreover, a user can easily increase the level of security by simply substituting or adding keyfobs to its security system.

Certain modifications of the present invention have been discussed above. Other modifications will occur to those practicing in the art of the present invention. For example, the reader 12 is shown in FIG. 1 as comprising the processor 14 and the transceiver 16 as separate devices. Instead, the functions of the processor 14 and the transceiver 16 may be combined into one device or separated into more than two devices.

Also, the power supply 32 may be a battery, and the power supply 50 may be a button that causes generation of power. Alternatively, both of the power supplies 32 and 50 may be batteries. As a further alternative, the power supplies 32 and/or 50 may be of the type that converts the RF stimulus signal to power in order to power their corresponding electronics.

Moreover, it may be inferred from the above description that the security system 10 uses only the badge 20 or the keyfob 24 even though the reader 12 is capable of reading both. However, the security system 10 may be arranged to include both the badge 20 and the keyfob 24. For example, multiple readers may be located throughout a facility such that access to lower security areas or devices or processes may be permitted to holders of the badge 20 while access to higher security areas or devices or processes may be permitted to only those who hold the keyfob 24.

Furthermore, as described above, the transceivers 16, 28, and 42 are arranged to transmit and/or receive RF signals. However, the transceivers 16, 28, and 42 may instead be arranged to transmit and/or receive other types of signals such as ultrasonic signals, infrared signals, etc.

Additionally, as described above, the badge 20 transmits an authentication code to the transceiver 16 in response to the RF stimulus signal transmitted by the transceiver 16. Alternatively, the badge 20 may be arranged to transmit the authentication code independently of the RF stimulus signal. In this case, it may be desirable to dispense with the RF stimulus signal altogether, particularly if the keyfob 24 also does not require the RF stimulus signal.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1. A security system reader comprising:
a transceiver that transmits a stimulus signal and that receives a signal containing an authentication code; and,
a processor that determines whether the received authentication code is from a badge or a fingerprint keyfob, and that performs an authentication of the authentication code dependent upon whether the authentication code is from the badge or from the fingerprint keybob.

2. The security system reader of claim 1 wherein the authentication code from the fingerprint keyfob comprises a fingerprint signature and an identifier, and wherein the processor is arranged to perform an authentication of the authentication code based upon both the fingerprint signature and the identifier in the authentication code from the fingerprint keyfob.

3. The security system reader of claim 2 wherein the identifier in the authentication code from the fingerprint keyfob comprises a rolling identifier.

4. The security system reader of claim 2 wherein the fingerprint signature comprises a digitized fingerprint signature.

5. The security system reader of claim 2 wherein the processor compares the fingerprint signature to fingerprint signatures in a list of fingerprint signatures and also compares the identifier in the authentication code from the fingerprint keyfob to an identifier maintained by the processor.

6. The security system reader of claim 5 wherein the identifier in the authentication code from the fingerprint keyfob comprises a rolling identifier, and wherein the processor compares the rolling identifier in the authentication code from the fingerprint keyfob to a rolling identifier maintained by the processor.

7. A method of providing access comprising:
receiving a signal containing an authentication code;
determining whether the authentication code is from a badge or a fingerprint keyfob;
determining whether the authentication code is authentic dependent upon whether the authentication code is from the badge or from the fingerprint keybob; and,
if the authentication code is authentic, permitting access.

8. The method of claim 7 wherein the authentication code from the fingerprint keyfob comprises a fingerprint signature and an identifier, and wherein the determining of whether the authentication code is authentic comprises determining whether both the fingerprint signature and the identifier in the authentication code from the fingerprint keyfob are authentic.

9. The method of claim 8 wherein the identifier in the authentication code from the fingerprint keyfob comprises a rolling identifier.

10. The method of claim 8 wherein the fingerprint signature comprises a digitized fingerprint signature.

11. The method of claim 8 wherein the determining of whether the authentication code is authentic comprises:
comparing the fingerprint signature to fingerprint signatures in a list of fingerprint signatures; and,
comparing the identifier in the authentication code from the fingerprint keyfob to a separately maintained identifier.

12. The method of claim 11 wherein the identifier in the authentication code from the fingerprint keyfob comprises a rolling identifier, and wherein the comparing of the identifier in the authentication code from the fingerprint keyfob to a separately maintained identifier comprises comparing the rolling identifier in the authentication code from the fingerprint keyfob to a separately generated rolling identifier.

13. The method of claim 7 further comprising transmitting a stimulus signal that causes at least one of the badge and the keyfob to transmit the signal containing the authentication code.

14. A method of providing access comprising:
receiving a signal containing an authentication code;
determining whether the authentication code is from a badge or a keyfob;
determining whether the authentication code is authentic; and,
if the authentication code is authentic, permitting access.

15. The method of claim 14 further comprising transmitting a stimulus signal that causes at least one of the badge and the keyfob to transmit the signal containing the authentication code.

16. The method of claim 14 wherein the authentication code from the keyfob comprises first and second portions, wherein the first and second portions are different types of codes, and wherein the determining of whether the authentication code is authentic comprises determining whether both the first and second portions are authentic.

17. The method of claim 16 wherein the first portion comprises a rolling identifier.

18. The method of claim 16 wherein the determining of whether the authentication code is authentic comprises:
comparing the first portion to a list; and,
comparing the second portion to a separately maintained code.

19. The method of claim 18 wherein the second portion comprises a rolling identifier, and wherein the comparing of the second portion to a separately maintained code comprises comparing the rolling identifier to a separately generated rolling identifier.

20. The method of claim 14 wherein the authentication code from the keyfob comprises a fingerprint signature and an identifier, and wherein the determining of whether the authentication code is authentic comprises determining whether both the fingerprint signature and the identifier are authentic.

21. The method of claim 20 wherein the identifier in the authentication code from the keyfob comprises a rolling identifier.

22. The method of claim 20 wherein the fingerprint signature comprises a digitized the fingerprint signature.

23. The method of claim 20 wherein the determining of whether the authentication code is authentic comprises:
comparing the fingerprint signature to fingerprint signatures in a list of fingerprint signatures; and,
comparing the identifier in the authentication code from the keyfob to a separately maintained identifier.

24. The method of claim 23 wherein the identifier in the authentication code from the keyfob comprises a rolling identifier, and wherein the comparing of the identifier in the authentication code from the keyfob to a separately maintained identifier comprises comparing the rolling identifier to a separately generated rolling identifier.
